(19) United States
(12) Patent Application Publication
(10) Pub. No.: US 2024/0278621 A1
(43) Pub. Date: Aug. 22, 2024

(54) VEHICLE COMPONENT AND METHOD FOR MANUFACTURING HEATER MODULE

(71) Applicant: TOYODA GOSEI CO., LTD., Kiyosu-shi, Aichi-ken (JP)

(72) Inventors: Kenjiro MORIMOTO, Kiyosu-shi (JP); Yuji HOTTA, Kiyosu-shi (JP)

(21) Appl. No.: 18/415,145

(22) Filed: Jan. 17, 2024

(30) Foreign Application Priority Data
Feb. 21, 2023 (JP) 2023-025224

(51) Int. Cl. B60H 1/22

(52) U.S. Cl. CPC B60H 1/2215

(57) ABSTRACT

A vehicle component includes a base and a heater module. The heater module includes a heater wire that generates heat when energized. The heater wire includes a first surface and a second surface. The first surface is a surface of the heater wire opposite to the base when the heater module is arranged on the outer surface of the base, and is a surface of the heater wire facing the base when the heater module is arranged on the inner surface of the base. The second surface is a surface of the heater wire facing the base when the heater module is arranged on the outer side of the base, and is a surface of the heater wire opposite to the base when the heater module is arranged on the inner side of the base. The first surface has a larger surface area than the second surface.

### BACKGROUND

### 1. Field

The present disclosure relates to a vehicle component including a heater module and to a method for manufacturing a heater module.

### 2. Description of Related Art

Examples of such a vehicle component include a radome used for a vehicle on-board radar device disclosed in Japanese Laid-Open Patent Publication No. 2021-43019. Such a vehicle component is formed by stacking a base layer, a decorative layer, and a heater layer in this order from the outer side. A heater element included in the heater layer is formed using, for example, a nichrome wire.

In the vehicle component, the nichrome wire of the heater element typically has a circular cross-section. Thus, when the heater element is energized, heat is released from the heater layer almost evenly. Accordingly, the amount of heat released from the heater layer is substantially the same between the outer and inner surfaces of the vehicle component.

In the vehicle component, the heat released from the heater layer is used to remove ice and snow that adhere to the outer surface of the base layer, which defines the outer surface of the vehicle component. Thus, the heat emitted from the heater layer toward the inner surface of the vehicle component is wasted. Accordingly, there is room for improvement in efficiently heating the outer surface of the vehicle component.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

A vehicle component according to an aspect of the present disclosure includes a base and a heater module arranged on an outer surface or an inner surface of the base. The heater module includes a heater wire that generates heat when energized. The heater wire includes a first surface and a second surface. The first surface is a surface of the heater wire opposite to the base when the heater module is arranged on the outer surface of the base, and is a surface of the heater wire facing the base when the heater module is arranged on the inner surface of the base. The second surface is a surface of the heater wire facing the base when the heater module is arranged on the outer side of the base, and is a surface of the heater wire opposite to the base when the heater module is arranged on the inner side of the base. The first surface has a larger surface area than the second surface.

A method for manufacturing a heater module according to an aspect of the present disclosure is provided. The heater module is included in a vehicle component having a base. The heater module is arranged on an outer surface or an inner surface of the base. The heater module includes a heater wire that generates heat when energized. The heater wire includes a first surface and a second surface. The first surface is a surface of the heater wire opposite to the base when the heater module is arranged on the outer surface of the base, and is a surface of the heater wire facing the base when the heater module is arranged on the inner surface of the base. The second surface is a surface of the heater wire facing the base when the heater module is arranged on the outer side of the base, and is a surface of the heater wire opposite to the base when the heater module is arranged on the inner side of the base. The method includes forming the heater wire, having recesses and projections on the first surface, by depositing metal in a plating solution that does not have a leveling property.

Other features and aspects will be apparent from the following detailed description, the drawings, and the claims.

### BRIEF DESCRIPTION OF DRAWINGS

FIG. 1 is a schematic cross-sectional view showing a millimeter wave transmissive cover according to an embodiment.

FIG. 2 is a block diagram illustrating the steps that manufacture the heater module.

FIG. 3 is a graph comparing the relationship between the energization time and the temperature in a heater wire formed by copper plating, focusing on the first surface and the second surface.

FIG. 4 is a graph showing the relationship between the energization time and the temperature in a heater wire formed by nickel plating, focusing on the first surface and the second surface.

FIG. 5 is a graph comparing the relationship between an arithmetic mean roughness Sa and the temperature rise characteristic of the first surface of the heater wire, with the reference value assigned as 1 to the second surface.

FIG. 6 is a graph showing the relationship between a developed area ratio Sdr of the first surface of the heater wire to the second surface and the temperature rise characteristic of the first surface, with the reference value assigned as 1 to the second surface.

FIG. 7 is a schematic cross-sectional view showing a millimeter wave transmissive cover according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the modes, devices, and/or systems described. Modifications and equivalents of the modes, devices, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A millimeter wave transmissive cover according to an embodiment will now be described with reference to the drawings. The millimeter wave transmissive cover is a vehicle component. In the following description, the direction in which a vehicle advances forward will be referred to as the front, and the reverse direction will be referred to as the rear.

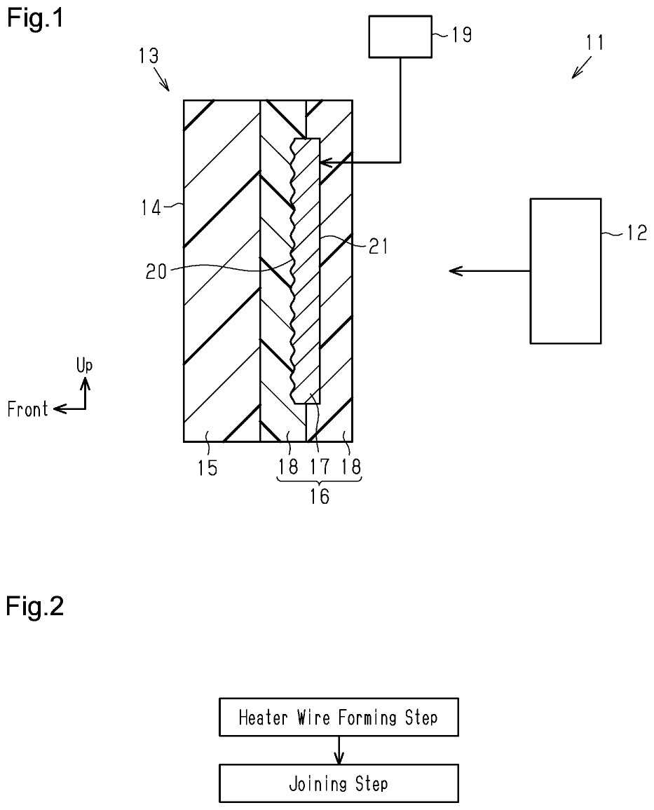

As shown in FIG. 1, a front-monitoring millimeter wave radar device 12 is mounted on the front end of a vehicle 11. The millimeter wave radar device 12 is an example of a radar device that transmits and receives electromagnetic waves. The millimeter wave radar device 12 functions to transmit millimeter waves of electromagnetic waves toward the front of the vehicle 11 and receive the millimeter waves that have struck and have been reflected by an object outside the vehicle 11. Millimeter waves are radio waves each having a wavelength of 1 mm to 10 mm and a frequency of 30 GHz to 300 GHz.

As described above, the millimeter wave radar device 12 transmits millimeter waves toward the front of the vehicle 11. Thus, the direction in which the millimeter wave radar device 12 transmits the millimeter waves coincides with the direction from the rear to the front of the vehicle 11. The front in the transmission direction of millimeter waves substantially matches the front of the vehicle 11. The rear in the transmission direction of millimeter waves substantially matches the rear of the vehicle 11. Thus, in the following description, the front in the transmission direction of millimeter waves is simply referred to as “frontward” or “front,” and the rear in the transmission direction of millimeter waves is simply referred to as “rearward” or “rear.”

### Millimeter Wave Transmissive Cover 13

As shown in FIG. 1, a plate-shaped millimeter wave transmissive cover 13, which is an example of the vehicle component, is disposed in front of the millimeter wave radar device 12. The millimeter wave transmissive cover 13 is employed in, for example, an emblem, a front grille, or the like of the vehicle 11. The millimeter wave transmissive cover 13 is arranged upright such that its front surface (outer surface) faces the front of the vehicle 11 and its rear surface (inner surface) faces the rear of the vehicle 11. The front surface of the millimeter wave transmissive cover 13 defines an ornamental surface 14 of the millimeter wave transmissive cover 13. The millimeter wave transmissive cover 13 includes a base 15 and a plate-shaped heater module 16. The heater module 16 is arranged on the rear (inner) surface of the base 15.

### Base 15

As shown in FIG. 1, the base 15 is formed into a plate shape by performing, for example, injection molding using a synthetic resin that permits the passage of millimeter waves. The front (outer) surface of the base 15 defines the front surface of the millimeter wave transmissive cover 13, that is, the ornamental surface 14 of the millimeter wave transmissive cover 13. The synthetic resin material used to form the base 15 may be transparent or opaque.

Examples of the synthetic resin materials used for forming the base 15 include polypropylene (PP) resin, polycarbonate (PC) resin, acrylonitrile-butadiene-styrene (ABS) copolymer resin, acrylonitrile-ethylene-propylene-diene-styrene (AES) resin, polymethyl methacrylate (PMMA) resin, acrylonitrile-styrene-acrylate (ASA) copolymer resin, and PMMA resin including ASA resin.

### Heater Module 16

As shown in FIG. 1, the heater module 16 is disposed adjacent to the rear (inner) surface of the base 15. The heater module 16 includes a heater wire 17 and two films 18 that sandwich the heater wire 17. The heater wire 17 is made of, for example, metal such as copper and nickel.

The heater wire 17 is arranged to form a predetermined pattern between the two films 18. The heater wire 17 is electrically connected to the power supply circuit 19. The heater wire 17 generates heat when energized by the power supply circuit 19. The surface of the heater wire 17 facing the base 15 is a first surface 20. The surface of the heater wire 17 opposite to the base 15 is a second surface 21.

The first surface 20 is an uneven surface having a large number of recesses and projections. The second surface 21 is a flat surface. Thus, the first surface 20 has a larger surface area than the second surface 21. A developed area ratio Sdr of the first surface 20 to the second surface 21 is set to be 10% or greater. The developed area ratio Sdr is a parameter that, measured in compliance with ISO 25178, represents how much the developed area (surface area) of the defined region has increased relative to the area of the defined region.

The first surface 20 is formed such that an arithmetic mean roughness Sa is 0.15 μm or greater. The arithmetic mean roughness Sa is a value representing a parameter in the height direction measured in accordance with ISO 25178.

The two films 18 have a heat resistance. The two films 18 are, for example, polyimide films. The two films 18 protect and insulate the heater wire 17.

### Method for Manufacturing Heater Module 16

As shown in FIG. 2, the heater module 16 is manufactured by sequentially performing a heater wire forming step and a joining step.

### Heater Wire Forming Step

In the heater wire forming step, the heater wire 17, which has recesses and projections on the first surface 20, is formed by depositing plating metal in a plating solution (electrolytic solution) that does not have a leveling property. Specifically, direct current is passed through the plating solution with a plating metal, which serves as an anode, and a metal to be plated, which serves as a cathode, immersed in the plating solution. As a result, at the anode, the plating metal dissolves into the plating solution through oxidation reactions. Further, at the cathode, the plating metal is deposited by reduction reactions, leading to the growth of the plating film.

The metal to be plated, which is the cathode, is shaped such that the plating film forms a predetermined pattern, thereby becoming the heater wire 17. Further, since the plating solution does not have a leveling property, a large number of recesses and projections are formed on one surface of the plating film, which becomes the first surface 20 of the heater wire 17. That is, the heater wire 17, which includes the first surface 20 on which an uneven surface is formed, is formed on the outer surface of the metal to be plated, which is the cathode. In this case, it is preferred that the plating solution include an additive that facilitates the formation of recesses and projections on one surface of the plating film.

### Joining Step

In the joining step, two films 18 are first prepared. Then, the heater wire 17 formed on the outer surface of the metal to be plated, which is the cathode, through the heater wire forming step is moved onto one of the two films 18. Further, the other film 18 is overlaid onto the heater wire 17. This causes the heater wire 17 to be held between the two films 18. Subsequently, the heater wire 17 held between the two films 18 is thermally pressed. Accordingly, the heater module 16 is obtained by thermally bonding the two films 18 to each other.

The heater module 16 obtained in this manner is joined to the rear surface (inner surface) of the base 15 such that the first surface 20 of the heater wire 17 faces the base 15. This forms the millimeter wave transmissive cover 13. In this case, the base 15 and the heater module 16 may be joined through insert-molding of the base 15 using the heater module 16 as an insert. Alternatively, the base 15 and the heater module 16 may be joined using adhesive or a double-sided adhesive tape that permits the passage of millimeter waves.

### Operation of Millimeter Wave Transmissive Cover 13

Based on the transmitted and received millimeter waves, the millimeter wave radar device 12 recognizes an object and detects the distance between the object and the vehicle 11, the relative speed, and the like. However, when ice and snow adhere to the ornamental surface 14 of the millimeter wave transmissive cover 13, the millimeter waves transmitted and received by the millimeter wave radar device 12 attenuate. This lowers the detection performance of the millimeter wave radar device 12.

Thus, when ice and snow adhere to the ornamental surface 14 of the millimeter wave transmissive cover 13, the power supply circuit 19 energizes the heater wire 17. Then, the heater wire 17 generates heat when energized by the power supply circuit 19. Since the first surface 20 of the heater wire 17 has a larger surface area than the second surface 21, the following result is obtained.

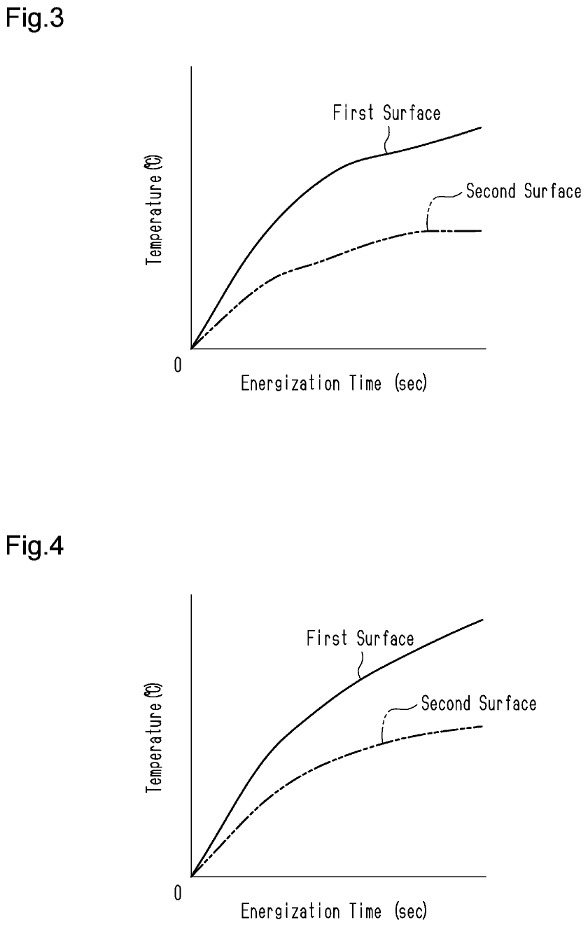

FIG. 3 is a graph comparing the relationship between the energization time and the temperature in the heater wire 17 formed by copper plating, focusing on the first surface 20 and the second surface 21. FIG. 4 is a graph comparing the relationship between the energization time and the temperature in the heater wire 17 formed by nickel plating, focusing on the first surface 20 and the second surface 21. The graphs of FIGS. 3 and 4 indicate that the temperature of the first surface 20 is higher than that of the second surface 21.

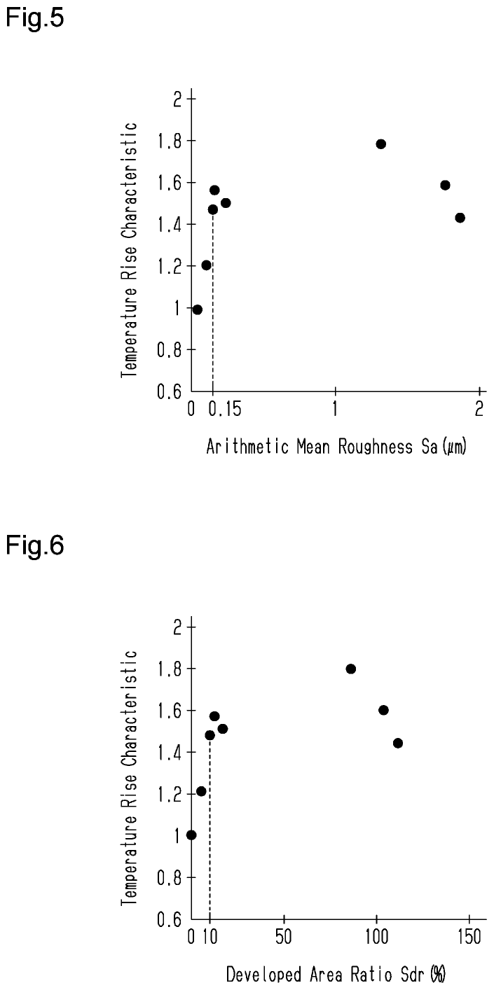

FIG. 5 is a graph showing the relationship between the arithmetic mean roughness Sa and a temperature rise characteristic (ease of temperature increase) of the first surface 20 of the heater wire 17, with the reference value assigned as 1 to the second surface 21. The graph of FIG. 5 indicates that when the arithmetic mean roughness Sa of the first surface 20 is 0.15 μm or greater, the temperature rise characteristic of the first surface 20 improves to approximately 1.5 to 1.8 times that of the second surface 21.

Further, FIG. 6 is a graph showing the relationship between the developed area ratio Sdr of the first surface 20 of the heater wire 17 to the second surface 21 and the temperature rise characteristic (ease of temperature rise) of the first surface 20, with the reference value assigned as 1 to the second surface 21. The graph of FIG. 6 indicates that when the developed area ratio Sdr to the second surface 21 of the first surface 20 is 10% or greater, the temperature rise characteristic of the first surface 20 improves to approximately 1.5 to 1.8 times that of the second surface 21.

Thus, the amount of heat released by the heater wire 17 is much greater on the base 15 (on the first surface 20) than on the opposite side of the base 15 (on the second surface 21). Thus, most of the heat released from the heater wire 17 is transferred to the ornamental surface 14 of the millimeter wave transmissive cover 13, which is the front surface of the base 15. That is, the heat released from the heater wire 17 efficiently heats the ornamental surface 14. This readily melts the ice and snow that adhere to the ornamental surface 14, and thus limits the attenuation of millimeter waves that occurs due to the ice and snow. As a result, the detection performance of the millimeter wave radar device 12 is maintained.

### Advantages of Embodiment

The embodiment described above in detail has the following advantages.
(1) In the millimeter wave transmissive cover 13, the first surface 20, which is the surface of the heater wire 17 facing the base 15, has a larger surface area than the second surface 21, which is the surface of the heater wire 17 opposite to the base 15.

In the above configuration, the amount of heat released by the heater wire 17 is greater on the first surface 20 than on the second surface 21. This allows the heater wire 17 to efficiently heat the base 15 on the outer surface of the millimeter wave transmissive cover 13. This efficiently heats the outer surface of the millimeter wave transmissive cover 13.
(2) In the millimeter wave transmissive cover 13, the developed area ratio Sdr of the first surface 20 to the second surface 21 is greater than or equal to 10%.

In the above configuration, as seen in the graph of FIG. 6, the amount of heat released from the heater wire 17 from the first surface 20 is larger than the amount of heat released from the second surface 21.
(3) In the millimeter wave transmissive cover 13, the arithmetic mean surface roughness Sa of the first surface 20 is greater than or equal to 0.15 μm.

In the above configuration, as seen in the graph of FIG. 5, the amount of heat released from the heater wire 17 from the first surface 20 is larger than the amount of heat released from the second surface 21.
(4) The method for manufacturing the heater module 16 includes the heater wire forming step. In the heater wire forming step, the heater wire 17 having recesses and projections on the first surface 20 is formed by depositing metal using a plating solution that does not have a leveling property.

The above method allows the heater wire 17 having recesses and projections to be formed on the first surface 20 with plating (deposited metal). This eliminates the need to form recesses and projections on the first surface 20 in the subsequent step. This facilitates the manufacturing of the heater wire 17 in which the first surface 20 has a larger surface area than the second surface 21. Thus, the manufacturing of the heater module 16 is facilitated.

### Modifications

The above embodiment may be modified as follows. The above embodiment and the following modifications can be combined as long as the combined modifications remain technically consistent with each other.

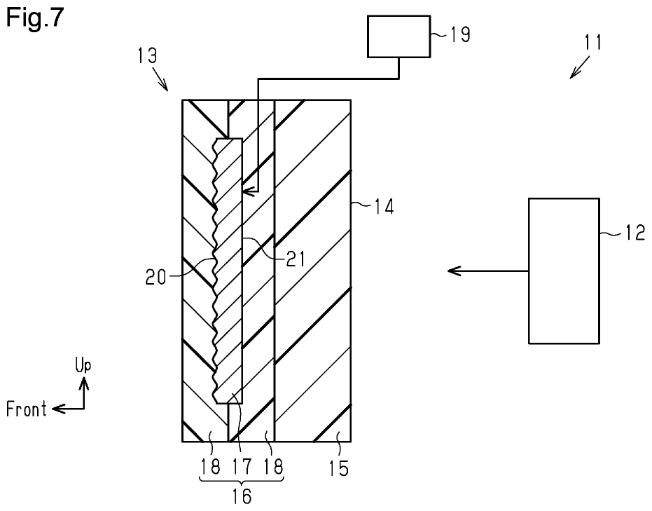

As shown in FIG. 7, the heater module 16 may be arranged on the front (outer) side of the base 15. In this case, the heater module 16 is arranged such that the first surface 20 of the heater wire 17 is opposite to the base 15 and the second surface 21 of the heater wire 17 faces the base 15.

The arithmetic mean surface roughness Sa of the first surface 20 of the heater wire 17 does not necessarily have to be 0.15 μm or more.

In the heater wire 17, the developed area ratio Sdr of the first surface 20 to the second surface 21 does not necessarily have to be 10% or greater.

At least one of the two films 18 may be omitted.

The heater wire 17 may be, for example, a metal wire having a circular or polygonal cross-section.

In the method for manufacturing the heater module 16, the films 18 may be disposed on the outer surface of the metal to be plated, which is the cathode, so that the plating metal is directly deposited on the films 18 to form the heater wire 17.

The vehicle component is not limited to the millimeter wave transmissive cover 13, but may be an infrared transmissive cover that permits the passage of infrared rays or may be a rear window.

The millimeter wave radar device 12, which transmits and receives millimeter waves (electromagnetic waves) used to detect an object outside the vehicle, does not have to be a front-monitoring device, but may be a rear-monitoring device.

The radar device may be an infrared radar device that transmits and receives infrared rays (electromagnetic waves).

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A vehicle component, comprising:
a base; and
a heater module arranged on an outer surface or an inner surface of the base, wherein
the heater module includes a heater wire that generates heat when energized,
the heater wire includes a first surface and a second surface,
the first surface is a surface of the heater wire opposite to the base when the heater module is arranged on the outer surface of the base, and is a surface of the heater wire facing the base when the heater module is arranged on the inner surface of the base,
the second surface is a surface of the heater wire facing the base when the heater module is arranged on the outer side of the base, and is a surface of the heater wire opposite to the base when the heater module is arranged on the inner side of the base, and
the first surface has a larger surface area than the second surface.

2. The vehicle component according to claim 1, wherein
a developed area ratio Sdr of the first surface to the second surface is greater than or equal to 10%.

3. The vehicle component according to claim 1, wherein
an arithmetic mean roughness Sa of the first surface is 0.15 μm or greater.

4. A method for manufacturing a heater module included in a vehicle component having a base, the heater module being arranged on an outer surface or an inner surface of the base, and the heater module including a heater wire that generates heat when energized, wherein
the heater wire includes a first surface and a second surface,
the first surface is a surface of the heater wire opposite to the base when the heater module is arranged on the outer surface of the base, and is a surface of the heater wire facing the base when the heater module is arranged on the inner surface of the base,
the second surface is a surface of the heater wire facing the base when the heater module is arranged on the outer side of the base, and is a surface of the heater wire opposite to the base when the heater module is arranged on the inner side of the base, and
the method comprises:
forming the heater wire, having recesses and projections on the first surface, by depositing metal in a plating solution that does not have a leveling property.
